(19) United States
(12) Patent Application Publication
(10) Pub. No.: US 2009/0145946 A1
(43) Pub. Date: Jun. 11, 2009

(54) Cassette of Cassette Type Stapler

(75) Inventor: Yoshiyuki Ebihara, Tokyo (JP)

Correspondence Address: GREENBERG TRAURIG, LLP, 77 WEST WACKER DRIVE, SUITE 3100, CHICAGO, IL, 60601-1732, US

(73) Assignee: e-Top Corporation

(21) Appl. No.: 12/198,293

(22) Filed: Aug. 26, 2008

Related U.S. Application Data
(63) Continuation of application No. 10/540,738, filed on Jun. 24, 2005, now abandoned.

(30) Foreign Application Priority Data
Dec. 26, 2002 (JP) 376144/2002

(51) Int. Cl. B25C 5/16

(52) U.S. Cl. 227/119; 227/120

(57) ABSTRACT

A cassette of a cassette type stapler, having a holder structural body (1), staple guides (8), and a spring engaging device (9) of the holder structural body molded integrally with each other, with a spring is fitted to a spring engaging device (9) of the holder structural body and the feeder projection (21) of a feeder (20), which is configured to push a staple forward.

The present application is a continuation of, and claims priority of, U.S. Ser. No. 10/540,738, presently pending, which was the US national phase of PCT/JP03/17039, filed 26 Dec. 2003.

### THE TECHNICAL FIELD

The present invention relates to a cassette to be used in a cassette type stapler and to a holder structure to be used in said cassette.

### PRIOR ART

As the cassette for the cassette type stapler of the prior art, there are a cassette disclosed in JP-A-62-218080 and a cassette disclosed in JP-A-6347076. A cassette 80 (FIG. 59 to FIG. 61) disclosed in JP-A-62-218080 widely spreads in the market. Not only a holder member 81 but also a feeder device 82 and a rod structure 86 (FIG. 60) are essential in the cassette 80. The holder member 81 is formed into a box shape having its back wall removed, and a cap 87 of the rod structure 86 functions as the back wall of the holder member. Specifically, the assembly of the cassette 80 is completed by mounting staples 84 and the feeder device 82 in the recited order from the back of the holder member 81, by mounting a rod 88 of the rod structure 86 having a spring 85 attached thereto, and by integrating the rod structure 86 and the holder member 81 so that an engaging projection 89 of the rod structure 86 snugly in the hole 90 of the cassette. Thus, the cassette 80 is mounted in the single action and is assembled easily to some extent. In the course of the mass production, however, many labors are required for fitting the engaging projection of the rod structure in the hole of the cassette.

The cassette, as manufactured under the trade name of “CSV” by e-TOP Co., Ltd., for the cassette type stapler of the prior art is commercially available (FIG. 62 to FIG. 64). Not only the holder member but also a feeder 95 and a rod structure 93 are essential for the cassette of the trade name “CSV”. The holder member is completed with a plurality of members. Specifically, the holder member body is formed into a box shape having its bottom and back removed, and a holder member bottom wall 92 or a member different from the holder member body is fitted on the bottom of the holder member body whereas the rod structure 93 is fitted on the back of the holder member body. A spring 96 is attached to a rod 94 of the rod structure 93. In short, this cassette requires the numerous members, and its manufacture takes many labors in the mass production procedure.

### PROBLEMS THAT THE INVENTION IS TO SOLVE

In this invention, the mechanism to function as the outer case and the mechanism for guiding the staples are integrated.

In the invention, moreover, even at the mechanism to function as the outer box, the back wall or the bottom wall is not a separate member but is made integral. In other words, the two members essential for the cassette disclosed in IP-A-62-218080, that is, the holder 81 and the rod structure 87 are made of one member. In the invention, moreover, as the mechanism for guiding the staples, there is adopted not the mechanism, in which the spring is fitted on the rod-shaped member, but the structure, in which the spring engages directly at its one end with the holder body and at its other end with the feeder and in which the staples are guided to a predetermined position as they are driven. These structures need the member for bringing the spring into engagement with the holder body and the staple guide member. These members are also integrated with the holder.

In the invention, moreover, all of the mechanism to function as the outer case and the mechanism for guiding the staples are integrally molded by using one set of molds, while eliminating any of glue, weld and screws.

### MEANS FOR SOLVING THE PROBLEMS

There is provided a holder structure to be used as a cassette of a cassette type stapler, comprising: a holder member including a top side portion, a bottom side portion, a right side portion, a left side portion, a front side portion and a back side portion; and a staple guide member extending in the inside of said holder member in the axial direction of said holder member, wherein, in case the sections of X-Y directions of a portion forming said top side portion, a portion forming said bottom side portion, a portion forming said right side portion, a portion forming said left side portion, a portion forming said front side portion, a portion forming said back side portion and a portion forming said staple guide member are projected in one virtual plane in the X-Y directions, the section of one portion in the X-Y directions and the section of another portion in the X-Y directions are absent over each other in a Z-direction.

The cassette according to the invention is one to be used in the cassette type stapler. This cassette type stapler is used by mounting the cassette precharged with the staples in the stapler body.

The holder structure according to the invention has a holder member. This holder member is formed into a hexahedron composed of a top side portion, a bottom side portion, a right side portion, a left side portion, a front side portion and a back side portion. In connection with these top, bottom, right, left, front and back side portions, the prior art structure does not need any hole for driving the staples on principle, excepting the hole for the blade and the staple to pass through. For the structure to be integrally molded, however, the invention is provided with a number of holes in the top side portion and the bottom side portion. The locations of the holes have an important meaning in the invention, as will be described hereinafter.

The holder member functions as the outer box for housing the staples or the like.

The holder structure according to the invention has the staple guide member. This staple guide member extends in the holder member in the axial direction of the holder member. The staples engage with the staple guide in the holder. The staples move forward, when driven, and hence the staple guide extends in the axial direction of the holder member.

The mode of the staple guide is sufficient if it can engage with the staples and can guide their axial movements. The staple guide may be located either at a position for supporting the top backs of the staples or at a position for supporting the leading ends of the legs of the staples.

Herein: the X-direction means the longitudinal axis of the cassette; the Y-direction means the transverse axis of the cassette; and the Z-direction means the vertical axis of the cassette. The X-Y directions means the directions parallel to the X-Y plate (i.e., the plane defined by the X-axis and the Y-axis. The section in the X-Y directions means the section, which is cut in a plane parallel to the X-Y plate (i.e., the plane defined by the X-axis and the Y-axis).

In the holder structure according to the invention, in case the sections of X-Y directions of the portion forming the top side portion, the portion forming the bottom side portion, the portion forming the right side portion, the portion forming the left side portion, the portion forming the front side portion, the portion forming the back side portion and the portion forming the staple guide member are projected in one virtual plane in the X-Y directions, the section of one portion in the X-Y directions and the section of another portion in the X-Y directions are absent over each other in the Z-direction. As a result, it is possible to mold the cassette integrally. Specifically, the holder member and the staple guide member are made by a set of molds.

The state, in which the sections in the X-Y directions are absent over each other in the plus Z-axis direction in case the sections of all portions in the X-Y directions are projected in one virtual plane in the X-Y directions, means that the structure equipped with the holder member and the staple guide member is made by one set of molds when the cassette is to be manufactured. For this structure, of the six sides composing the holder member, the top side and the bottom side are individually provided many holes. The mold parts are parted in the Z-direction. As a result, the portions of the individual components in the sections in the X-Y directions cannot overlap in the mold parting direction. In case the top side of the holder and the bottom side of the holder are projected in one virtual plane in the X-Y directions, for example, the portions of the holes of the top side form the no-hole portions of the bottom side, whereas the portions of the holes of the bottom side form the no-hole portions of the top side.

There is provided a holder structure to be used as a cassette of a cassette type stapler, comprising: a holder member including a top side portion, a bottom side portion, a right side portion, a left side portion, a front side portion and a back side portion; and a holder spring engaging member, wherein, in case the sections of X-Y directions of a portion forming said top side portion, a portion forming said bottom side portion, a portion forming said right side portion, a portion forming said left side portion, a portion forming said front side portion, a portion forming said back side portion and a portion forming holder spring engaging member are projected in one virtual plane in the X-Y directions, the section of one portion in the X-Y directions and the section of another portion in the X-Y directions are absent over each other in a Z-direction.

The holder structure according to the invention is provided with the holder spring engaging member. This holder spring engaging member functions as a member for attaching the spring to the holder. The holder spring engaging member covers all the modes capable of performing a function to bring the spring into engagement.

The positions, at which the holder spring engaging member exists, are various according to the kinds of spring (e.g., a tension spring or a push spring) or the lengths of spring.

In the holder structure according to the invention, in case the sections of X-Y directions of the portion forming the top side portion, the portion forming the bottom side portion, the portion forming the right side portion, the portion forming the left side portion, the portion forming the front side portion, the portion forming the back side portion and the portion forming the holder spring engaging member are projected in one virtual plane in the X-Y directions, the section of one portion in the X-Y directions and the section of another portion in the X-Y directions are absent over each other in a Z-direction. As a result, it is possible to mold the cassette integrally. Specifically, the holder member and the holder spring engaging member are made by one set of molds.

The state, in which the sections in the X-Y directions are absent over each other in the plus Z-axis direction in case the sections of all portions in the X-Y directions are projected in one virtual plane in the X-Y directions, means that the structure equipped with the holder member and the holder spring engaging member is made by one set of molds when the cassette is to be manufactured. For this structure, of the six sides composing the holder member, the top side and the bottom side are individually provided many holes. The mold parts are parted in the Z-direction. As a result, the portions of the individual components in the sections in the X-Y directions cannot overlap in the mold parting direction. In case the top side of the holder and the bottom side of the holder are projected in one virtual plane in the X-Y directions, for example, the portions of the holes of the top side form the no-hole portions of the bottom side, whereas the portions of the holes of the bottom side form the no-hole portions of the top side.

There is provided a holder structure to be used in a cassette for a cassette type stapler, comprising: a holder member including a top side portion, a bottom side portion, a right side portion, a left side portion, a front side portion and a back side portion; a holder spring engaging member; and a staple guide member extending in the inside of said holder member in the axial direction of said holder member, wherein all the members are made integral, and wherein, in the sections of X-Y directions of a portion forming said top side portion, a portion forming said bottom side portion, a portion forming said right side portion, a portion forming said left side portion, a portion forming said front side portion, a portion forming said back side portion, a portion forming said holder spring engaging member, and a portion forming said staple guide member, the section of one portion in the X-Y directions and the section of another portion in the X-Y directions are absent over each other in a Z-direction.

The holder structure comprises both the holder spring engaging member and the staple guide member.

Moreover, the cassette according to the invention has the holder member, the staple guide member and the spring engaging member integrated with one another. In short, all the members are jointed to one another.

Also provided a holder structure characterized by comprising a spring guide inside of said holder structure.

Thus, the spring to be used in the holder structure having the spring guide is a tension spring having a considerable length. The spring guide is usually positioned in front of said holder spring engaging member.

There is provided a cassette for a cassette type stapler, comprising: a holder structure to be used as a cassette of a cassette type stapler including: a holder member including a top side portion, a bottom side portion, a right side portion, a left side portion, a front side portion and a back side portion; a holder spring engaging member; and a staple guide member extending in the inside of said holder member in the axial direction of said holder member, wherein all the members are made integral, and wherein, in case the sections of X-Y directions of a portion forming said top side portion, a portion forming said bottom side portion, a portion forming said right side portion, a portion forming said left side portion, a portion forming said front side portion, a portion forming said back side portion, a portion forming said holder spring engaging member, and a portion forming said staple guide member is projected in one virtual plane in the X-Y directions, the section of one portion in the X-Y directions and the section of another portion in the X-Y directions are absent over each other in a Z-direction; a feeder including a feeder spring engaging member; and a spring engaging at its one end with said holder spring engaging member and at its other end with said feeder spring engaging member.

This cassette is not charged with the staples. In this state, the final consumer discards the cassette. This cassette having no staple is recovered and recharged with the staples for reuse. Thus, the resources can be effectively exploited.

There is provided a cassette for a cassette type staples, which is characterized by comprising staples pushed forward by said feeder member to slide along said staple guide.

Usually, the cassette for cassette type staples according to the invention is delivered with the staples to the final consumer.

As described hereinbefore, the position, at which the holder spring engaging member of the holder structure exists, is various according to the kinds of spring (e.g., a tension spring or a push spring) or the lengths of spring.

In case the spring is a tension spring and is attached in an I-letter shape without engaging with the spring guide, the holder spring engaging member is usually located in front of the holder structure.

In case, on the other hand, the spring is a tension spring and is attached in a U-letter shape in engagement with the spring guide, the holder spring engaging member exists at least at the back of the spring guide. In case the spring is attached in the U-shape, the spring used is longer than that attached in the I-shape. The position of the holder spring engaging member is also determined by the length of the spring. In case the longest spring is used, the holder spring engaging member exists at the rear end in the holder.

The staple guide member functions to guide the staples in a predetermined direction when the staples engage with the feeder member so that it is pushed forward by the force of the spring attached at its one end to the feeder member. The staple guide member may support either the top backs of the staples or the leading ends of the legs of the staples.

Moreover, the staple guide member may be disposed on any wall such as the wall of the bottom side or the side portion of the holder member.

There is provided a cassette for a cassette type stapler, which is characterized in that the spring is a tension spring.

In case the spring is the tension spring, the spring engages at its one end with the holder spring engaging member and at its other end with the feeder spring engaging member. In case a short spring is used, it is attached in the I-shape so that its force pulls the feeder directly.

In this case, the short spring can be used to make the cassette short. Alternatively, the cassette is not shortened but can accommodate more staples.

There is provided a cassette for cassette type a stapler, which is characterized in that said holder structure has a spring guide, and in that said spring engages with said spring guide between said one end and said other end to have a U-letter shape.

The spring in this case is the tension spring. Moreover, the spring engages with the spring guide between its one end attached to the holder spring engaging member and at its other end attached to the feeder spring engaging member, and has its tensing direction U-turned at the portion of the spring guide. The spring used in this case is relatively long. According to the length of the spring used, the position of the holder spring engaging member is adjusted.

The spring for pushing the staples is not proper if it is excessively strong or weak, because it has to push the staples with a force to feed them reliably one by one. Therefore, the mode has to match such a long spring.

There is provided a cassette for a cassette type stapler, which is characterized in that the spring is a push spring.

In case the spring is the push spring, the holder spring engaging member is usually disposed near the trailing end of the holder member.

There is provided a cassette for a cassette type stapler, which is characterized in that said staple guide member supports the top backs of the staples.

This cassette is enabled to match both the staples having longer legs and the staples having shorter legs by locating the staple guide at a position for supporting the top backs of the staples and by making the height of the staple guide engageable with the staples having the long legs. By the staple guide, the staples are precisely guided forward so that the foremost one of the series staples precisely reaches a predetermined position for the staple driving action.

It is sufficient that the staple guide in this case may function to support the top backs of the staples. These top backs may be borne either by the top ends of the two sides parallel to the side of the holder member or by the top side of a smaller box-shaped member than the inner periphery of the staples. Moreover, the staple guide member may be disposed on the bottom side of the holder member or on the side of the holder member. In case the staple guide member is disposed on the bottom side, the aforementioned two parallel sides and the box-shaped member rise from the bottom side of the holder member.

There is provided a cassette for a cassette type stapler, which is characterized in that said staple guide member supports the leading ends of the legs of the staples.

The legs of the staples are located near the side wall of the holder member. In case, therefore, the staple guide member is used to support the leading ends of the legs of the staples, the staple guide member can be disposed on the side wall of the holder member. In this invention, all the members can be integral so that they can be manufactured by the paired molds. Therefore, it is highly effective that the wall of the bottom side of the holder member can be minimized. When the construction is made to have no overlap in the Z-direction, the absence of the wall of the bottom side makes it possible to realize a simpler and free structure.

In the absence of the bottom wall, moreover, the works from the bottom side are facilitated to mount the members such as the feeder, the spring or the staples to the holder structure.

There is provided a mold to be used for manufacturing a holder structure to be used in a cassette for a cassette type stapler, the holder structure comprising: a holder member including a top side portion, a bottom side portion, a right side portion, a left side portion, a front side portion and a back side portion; a holder spring engaging member; and a staple guide member extending in the inside of said holder member in the axial direction of said holder member, wherein all the members are made integral, and wherein, in the sections of X-Y directions of a portion forming said top side portion, a portion forming said bottom side portion, a portion forming said right side portion, a portion forming said left side portion, a portion forming said front side portion, a portion forming said back side portion, a portion forming said holder spring engaging member, and a portion forming said staple guide member, the section of one portion in the X-Y directions and the section of another portion in the X-Y directions are absent over each other in a Z-direction.

The mold of this case is sufficiently exemplified by a set of molds to be parted in the Z-direction.

### EMBODIMENT 1

FIG. 1 to FIG. 24 shows Embodiment 1. In Embodiment 1, the spring is a tension spring interposed in an I-letter shape between a spring engaging member rising at the front of a holder bottom face of a holder structure and a feeder device made separate from the holder structure. In Embodiment 1, moreover, a staple guide rises from the bottom wall of a holder member for supporting the staples on their top backs.

The I-shaped spring simplifies the structure of a cassette. Moreover, the spring used is relative short so that its most compressed length can be reduced to shorten the feeder. As a result, more staples can be packed at once. In other words, the holder structure can be made shorter.

As shown in FIG. 1 to FIG. 4, a holder structure 1 has a hexahedral outer box, which is composed of a holder front side 2, a holder right side 3, a holder top side 4, a holder left side 5, a holder bottom side 6 and a holder back side 7. This outer box constitutes a holder member (having no reference numeral). Many recesses 12 are formed in the holder top side 4. Many recesses 13 are also formed in the holder bottom side 6.

As shown in FIG. 9 to FIG. 11, the portions other than the recesses of the holder bottom side 6 exist in the portions corresponding to the recesses 12 of the holder top side 4, and the portions other than the recesses of the holder top side 4 exist in the portions corresponding to the recesses 13 of the holder bottom side 6. Moreover, a staple guide 8 and a spring engaging member 9 also exist only at the portions corresponding to the recesses 12 of the holder top side 4. The holder back side 7 also exists only at the portions corresponding to the recesses 12 of the holder top side 4. This structure makes it possible to mold all the members integrally. In order to explain the shape of the holder structure more precisely, the sectional views of the holder structure are shown in FIG. 13 to FIG. 17. FIG. 12 shows a back view of the holder structure.

The holder structure thus made can be integrally molded by a pair of molds to be vertically parted.

Inside of the holder structure 1, as shown in FIG. 5 and FIG. 6, the staple guide 8 rises from the wall of the holder bottom side 6. A beam 16 exists at the holder bottom 6. The beam 16 may be located at one portion in the longitudinal center portion of the holder structure, as shown in FIG. 5 and FIG. 6. The beam 16 may also be disposed in the plural portions other than the longitudinal center. The beam is provided for stabilizing the shape of the holder structure 1 and accordingly for preventing any looseness in the holder structure 1 thereby to stabilize the drive of the staple.

The holder structure shown in FIG. 23 and FIG. 24 is not provided with the beam at its holder bottom side. In case the looseness prevention can be made other than the beam by the material or the like of the holder structure, the beam can be dispensed with, as shown in FIG. 23 and FIG. 24. In the holder structure shown in FIG. 23 and FIG. 24, the staple guide is not filled, as called so, with the material so as to reduce the waste of material.

As shown in FIG. 7 and FIG. 8, staples 15 engage on their top backs with the staple guide 8. The height of the staple guide 8 and the leg length of the staples 15 match each other. By raising the staple guide 8 high, therefore, staples 15A having short legs, staples 15B having longer legs and staples 15C having more longer legs can be coped with one holder structure.

As shown in FIG. 20 and FIG. 21, a feeder 20 is important as separate from the holder structure. As shown in FIG. 18 and FIG. 19, the feeder 20 is provided with a feeder projection 21. Like the holder structure, the feeder 20 and the feeder projection 21 can also be integrally molded.

The cassette is completed by assembling the four components of the holder structure, the staples, the feeder and the spring 4, as shown in FIG. 20. Specifically, the assembly of the cassette is made by the following manner. The staples are inserted into the holder structure. The staples can be charged either into a recess 17 (FIG. 12) formed in the holder back side 7 of the holder structure or into the recess in the holder bottom side. One end of the spring is brought into engagement with the feeder projection of the feeder 20, and the feeder 20 is charged to the back of the staples already charged. The feeder 20 is charged like the staples into the recess 17 or the recess in the bottom of the holder. After this, the other end of the spring is brought into engagement with an engaging projection 10 of the spring engaging member 9.

When the cassette is to be mounted in the stapler body, a cassette engaging projection 14 (FIG. 3) is brought into engagement with such an engagement member of the stapler body as is disposed at a corresponding portion.

The state, in which the staples are used up, is shown in FIG. 21. In this state, the longitudinal size of the feeder 20 corresponds to the most contracted length of a spring 22.

### EMBODIMENT 2

Embodiment 2 is shown in FIG. 25A to FIG. 30. In Embodiment 2, as shown in FIG. 25A, a spring guide 27 exists in front of the holder structure 1, and a spring engaging member 29a exists near the longitudinal center. The engaging member may also have a shape, as indicated by 29b in FIG. 25B. In the case of the shape of the engaging member 29b, the engagement of the spring is easier than that of the case of the engaging member 29a.

FIG. 29 and FIG. 30 are sectional views showing the engagements among the holder structure, the feeder, the spring and the staples. FIG. 29 shows the state, in which the staples fully occupy, and FIG. 30 shows the state, in which the staples are used up.

A spring 32 is mounted in a U-letter shape among a spring engaging member 29, the spring guide 27 and a feeder projection 31 of a feeder device 30, which is made separate from the holder structure. The spring 32 is a tension spring longer than that of Embodiment 1. In Embodiment 2, moreover, the staple guide for supporting the staples from the inner face rises from the bottom wall as in Embodiment 1.

The spring is so relatively long that it does not push the staples excessively thereby to ensure precise staple feed.

In Embodiment 2, as shown in FIG. 26 to FIG. 28, the holder structure is made integral and can be integrally molded as in Embodiment 1.

### EMBODIMENT 3

Embodiment 3 is shown in FIG. 31 to FIG. 35. In Embodiment 3, as shown in FIG. 31 to FIG. 35, a spring guide 34 exists in front of the holder structure 1, and a spring engaging member 36 exists on the back. As can be imagined from the explanation of FIG. 29 and FIG. 30 (Embodiment 2), the spring is mounted in a U-letter shape among the spring engaging member 36, the spring guide 34 and the (not-shown) feeder projection of the feeder device, which is separate from the holder structure. The spring in Embodiment 3 is a tension spring longer than the spring of Embodiment 2. This longer spring does not push the stapler excessively thereby to make the staple feed precise. In addition, the feeder can be drastically shortened.

In Embodiment 3, moreover, the staple guide for supporting the staples from the back of the top rises from the bottom wall as in Embodiment 1 and Embodiment 2. The holder structure is made integral and can be integrally molded as in Embodiment 1 and Embodiment 2.

### EMBODIMENT 4

Embodiment 4 is shown in FIG. 36 to FIG. 43. FIG. 40 and FIG. 41 are perspective taken from the bottom back side of the holder structure. Unlike Embodiment 1 to Embodiment 3, Embodiment 4 is not provided with a substantial bottom wall (FIG. 40 and FIG. 41). In the absence of the substantial bottom wall, the staples, the feeder and the spring can be easily attached to the holder structure thereby to facilitate the works of assembling the cassette. In the absence of the bottom wall, the staples fall down. Therefore, the side wall is provided with side wall staple guides 42. Specifically, the trailing ends of the legs of the staples come into engagement with the upper faces 47 of the side wall staple guides 42.

In Embodiment 4, the leg lengths of the staples to match are determined by the positions of the side wall staple guides so that the structure can accept only one kind of staples.

In Embodiment 4, as shown in FIG. 36 to FIG. 39, a spring engaging member 43 exists in front of the holder structure 1. A spring 46 is mounted in an I-letter shape between the spring engaging member 43 and a feeder projection 45 of a feeder device 44 made separate from the holder structure, as shown in FIG. 42 and FIG. 43. The spring 43 is relatively short so that it takes a shorter length when it is compressed the most. In Embodiment 4, therefore, the holder structure can be made shorter in the longitudinal direction than those of Embodiment 2 and Embodiment 3.

FIG. 42 and FIG. 43 are sectional views showing the engagements among the holder structure, the feeder 44, the spring 46 and staplers 40. FIG. 42 shows the state, in which the staples fill up, and FIG. 43 shows the state, in which the staples are used up.

In Embodiment 4, as shown in FIG. 42 and FIG. 43, the holder structure is made integral and can be integrally molded, as in Embodiment 1 to Embodiment 3.

### EMBODIMENT 5

Embodiment 5 is shown in FIG. 44 to FIG. 48. Embodiment 5 is not provided with a substantial bottom wall, as in Embodiment 4. As shown in FIG. 47, the staples have their trailing leg ends engaging with the upper face of a side wall staple guide 52 provided on the side wall.

In Embodiment 5, as shown in FIG. 44 and FIG. 45, a spring engaging member 51 exists in front of the holder structure 1, and a spring engaging member 53 exists on the back of the same. As shown in FIG. 47 and FIG. 48, a spring 57 is mounted in a U-letter shape among the spring engaging member 53, the spring guide 51, and a feeder projection 56 of a feeder device 55 made separate from the holder structure. The spring of Embodiment 5 is a tension spring longer than that of Embodiment 4. The effects resulting from the long spring are similar to those of Embodiment 3.

In Embodiment 5, the holder structure is made integral and can be integrally molded as in Embodiment 1 to Embodiment 4.

### EMBODIMENT 6

Embodiment 6 is shown in FIG. 49 to FIG. 58. Like Embodiment 4 and Embodiment 5, a side wall staple guide 62 for supporting the trailing ends of the legs of the staples is disposed on the side wall, as shown in FIG. 49 and FIG. 50.

As shown in FIG. 57 and FIG. 58, a spring 67 is a push spring for engaging with a spring engaging member 63 at the trailing end of the holder structure and a feeder spring engaging portion 66 disposed at a feeder 65.

In Embodiment 6, as shown in FIG. 52 to FIG. 54, the holder structure is made integral and can be integrally molded, as in Embodiment 1 to Embodiment 5.

### EMBODIMENT 7

Embodiment 7 presents a method for manufacturing Embodiment 1 to Embodiment 6.

A mold corresponding to the holder structure of each Embodiment is prepared as two kinds of molds to match each other vertically. The material is poured into the mold, and the top part and the bottom part are removed. By once extracting the two top and bottom parts, therefore, it is possible to manufacture the holder structure which is composed of all the members such as the spring engaging member, the staple guide and so on, excepting the feeder.

### EFFECTS OF THE INVENTION

According to this invention, an integrally molded holder structure for use in the cassette of the cassette type stapler can be provided by a set of molds. The holder structure is obtained by once parting the molds so that the cost and the labors of manufacture can be remarkably lowered.

At the time of using the holder member, moreover, no trouble occurs, as might otherwise be caused due to removal of glue or screws.

The cassette according to this invention is completed by the four parts of the holder structure, the feeder, the spring and the staples so that it can be manufactured with less parts and at a remarkably low cost. Moreover, the labors are drastically reduced for the manufacture.

In case the cassette of this invention adopts the mechanism in which the staples are guided by the engagement of their top backs, the height of this staple guiding mechanism is adjusted to the largest length of the legs of the staples for ordinary use. As a result, the holder structure of one kind can be used for the cassette matching the staples of various leg lengths.

In case the cassette of this invention adopts the mechanism in which the staples are guided by the engagement with the trailing ends of the legs of the staples, the wall of the bottom of the holder structure can be minimized. As a result, it is possible to facilitate the works for attaching the feeder, the staples and the spring.

In case the cassette of this invention uses a long spring between the holder structure and the feeder, the staples can be pushed with a relatively weak force. In case a short spring is used, the cassette can be reduced in size or otherwise can be provided with more staples.

### BRIEF DESCRIPTION OF THE DRAWINGS

FIG. 1 is a perspective view showing a holder structure according to Embodiment 1 and taken in the direction from its front top.

FIG. 2 is an explanatory view showing the inside of the holder structure according to Embodiment 1.

FIG. 3 is a perspective view showing the holder structure according to Embodiment 1 and taken in the direction from its back top.

FIG. 4 is a perspective view showing the holder structure according to Embodiment 1 and taken in the direction from its back bottom.

FIG. 5 is an explanatory view showing the inside of the holder structure according to Embodiment 1.

FIG. 6 is an explanatory view showing the inside of the holder structure according to Embodiment 1.

FIG. 7 is an explanatory view showing the engagement between the holder structure according to Embodiment 1 and staples.

FIG. 8 is an explanatory view showing the engagement between the holder structure according to Embodiment 1 and the staples.

FIG. 9 is an explanatory view showing the holder structure according to Embodiment 1 and taken in the direction from its top.

FIG. 10 is an explanatory view showing the holder structure according to Embodiment 1 and taken in the direction from its bottom.

FIG. 11 is a sectional view along A-A′ of FIG. 9.

FIG. 12 is a back elevation of the holder structure according to Embodiment 1.

FIG. 13 presents a sectional view along A-A′, a sectional view along E-E′ and a sectional view along I-I′ of FIG. 11.

FIG. 14 is a sectional view along B-B′ of FIG. 11.

FIG. 15 is a sectional view along C-C′ of FIG. 11.

FIG. 16 presents a sectional view along D-D′, a sectional view along F-F′, a sectional view along H-H′ and a sectional view along J-J′ of FIG. 11.

FIG. 17 presents a sectional view along G-G′ and a sectional view along K-K′ of FIG. 11.

FIG. 18 is a perspective view showing a feeder according to Embodiment 1.

FIG. 19 is a sectional perspective view showing a feeder according to Embodiment 1.

FIG. 20 is a sectional view (in a staple-filled state) showing the engagement among the holder structure, the feeder, the spring and the staples according to Embodiment 1.

FIG. 21 is a sectional view (in a staple-used-up state) showing the engagement among the holder structure, the feeder and the spring according to Embodiment 1.

FIG. 22 shows the inside of another mode of the holder structure according to Embodiment 1.

FIG. 23 shows the inside of another mode of the holder structure according to Embodiment 1.

FIG. 24 shows the inside of another mode of the holder structure according to Embodiment 1.

FIG. 25A is an explanatory view showing the inside of a holder structure according to Embodiment 2.

FIG. 25B is an explanatory view showing the inside of the holder structure according to Embodiment 2.

FIG. 26 is an explanatory view showing the holder structure according to Embodiment 2 and taken in the direction from its top.

FIG. 27 is an explanatory view showing the holder structure according to Embodiment 2 and taken in the direction from its bottom.

FIG. 28 is a sectional view along A-A′ of FIG. 26.

FIG. 29 is a sectional view (in a staple-filled state) showing the engagement among the holder structure, the feeder, the spring and the staples according to Embodiment 2.

FIG. 30 is a sectional view (in a staple-used-up state) showing the engagement among the holder structure, the feeder and the spring according to Embodiment 2.

FIG. 31 is an explanatory view showing the inside of a holder structure according to Embodiment 3.

FIG. 32 is an explanatory view showing the inside of the holder structure according to Embodiment 3.

FIG. 33 presents an appearance of the holder structure according to Embodiment 3 and a transverse section at seven portions of the same holder structure.

FIG. 34 is an explanatory view showing the holder structure according to Embodiment 3 and taken from its bottom.

FIG. 35 shows a holder structure according to Embodiment 4.

FIG. 36 is an explanatory view showing the inside of the holder structure according to Embodiment 4.

FIG. 37 is an explanatory view showing the inside of the holder structure according to Embodiment 4.

FIG. 38 is a perspective view showing a holder structure according to Embodiment 4 and taken in the direction from its front top.

FIG. 39 is an explanatory view showing the inside of another mode of the holder structure according to Embodiment 4.

FIG. 40 is an explanatory view showing the inside of another mode of the holder structure according to Embodiment 4 and taken from its bottom back.

FIG. 41 is a perspective view of another mode of the holder structure according to Embodiment 4 and taken from its bottom back.

FIG. 42 is a sectional view (in a staple-filled state) showing the engagement among the holder structure, the feeder, the spring and the staples according to Embodiment 4.

FIG. 43 is a sectional view (in a staple-used-up state) showing the engagement among the holder structure, the feeder and the spring according to Embodiment 4.

FIG. 44 is an explanatory view showing the inside of a holder structure according to Embodiment 5.

FIG. 45 is an explanatory view showing the inside of the holder structure according to Embodiment 5.

FIG. 46 shows the holder structure according to Embodiment 5.

FIG. 47 is a sectional view (in a staple-filled state) showing the engagement among the holder structure, the feeder, the spring and the staples according to Embodiment 5.

FIG. 48 is a sectional view (in a staple-used-up state) showing the engagement among the holder structure, the feeder and the spring according to Embodiment 5.

FIG. 49 is an explanatory view showing the inside of a holder structure according to Embodiment 6.

FIG. 50 is an explanatory view showing the inside of the holder structure according to Embodiment 6.

FIG. 51 shows the holder structure according to Embodiment 6.

FIG. 52 is an explanatory view showing the holder structure according to Embodiment 6 and taken in the direction from its top.

FIG. 53 is an explanatory view showing the holder structure according to Embodiment 6 and taken in the direction from its bottom.

FIG. 54 is a sectional view-along A-A′ of FIG. 52.

FIG. 55 is a perspective view showing a feeder according to Embodiment 6.

FIG. 56 is a sectional perspective view showing a feeder according to Embodiment 6.

FIG. 57 is a sectional view (in a staple-filled state) showing the engagement among the holder structure, the feeder, the spring and the staples according to Embodiment 6.

FIG. 58 is a sectional view (in a staple-used-up state) showing the engagement among the holder structure, the feeder and the spring according to Embodiment 6.

FIG. 59 is an explanatory view showing a cassette of the prior art.

FIG. 60 is an explanatory view showing a rod structure to be used in the cassette of the prior art.

FIG. 61 is an explanatory view showing the cassette of the prior art.

FIG. 62 is an explanatory view showing the cassette of the prior art.

FIG. 63 is an explanatory view showing the cassette of the prior art.

FIG. 64 is an explanatory view showing the cassette of the prior art.

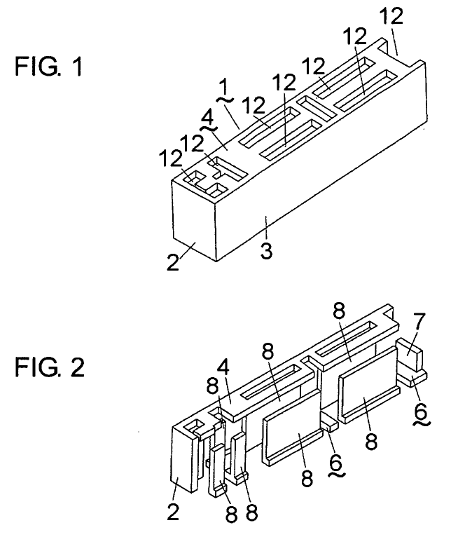

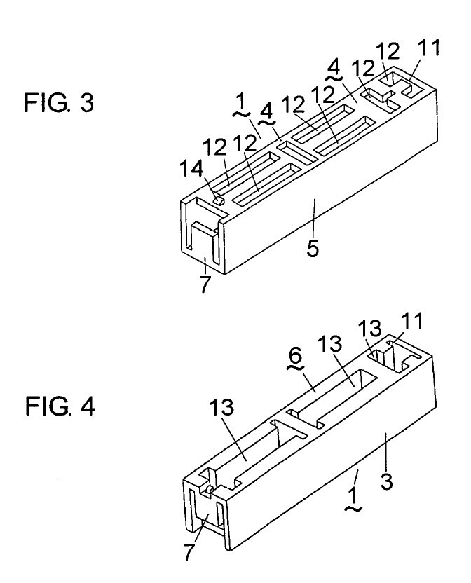

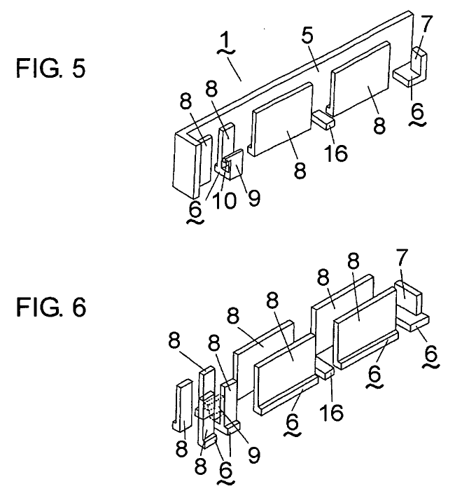

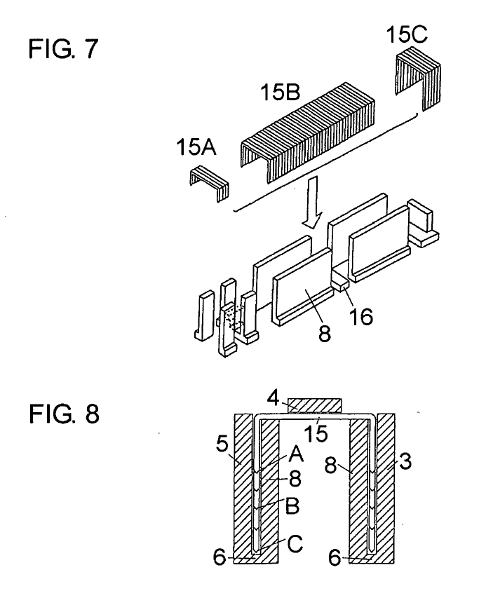

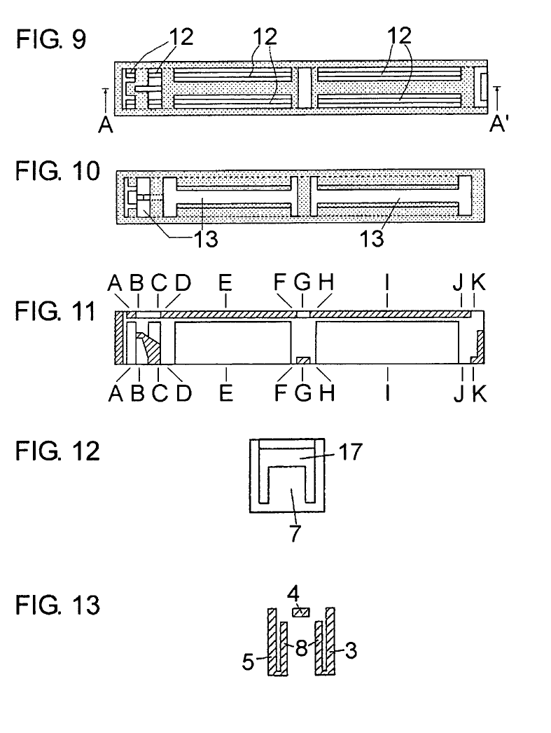

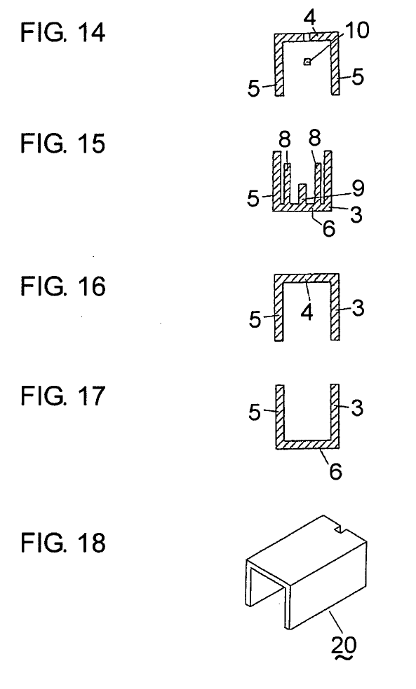

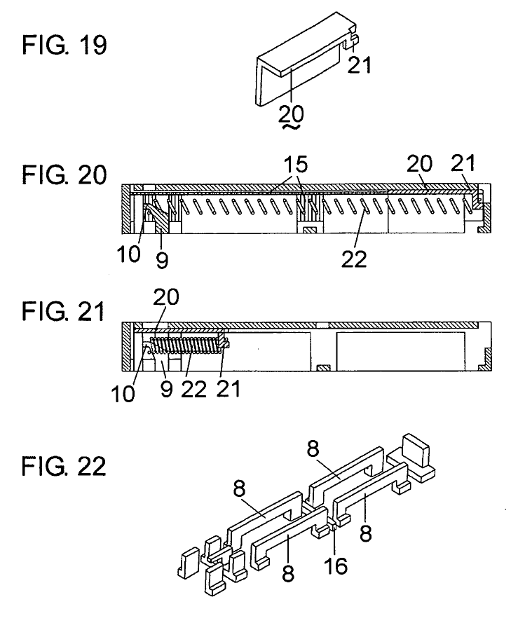

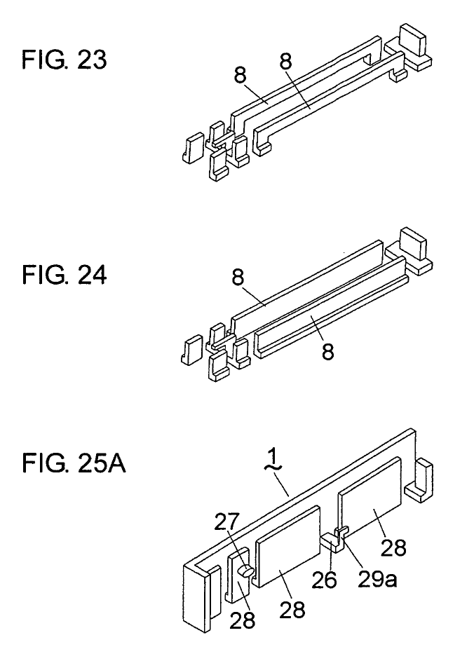

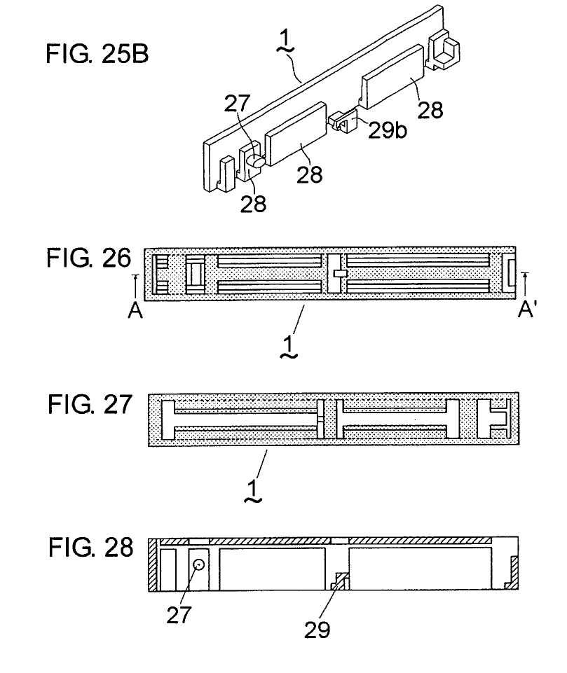

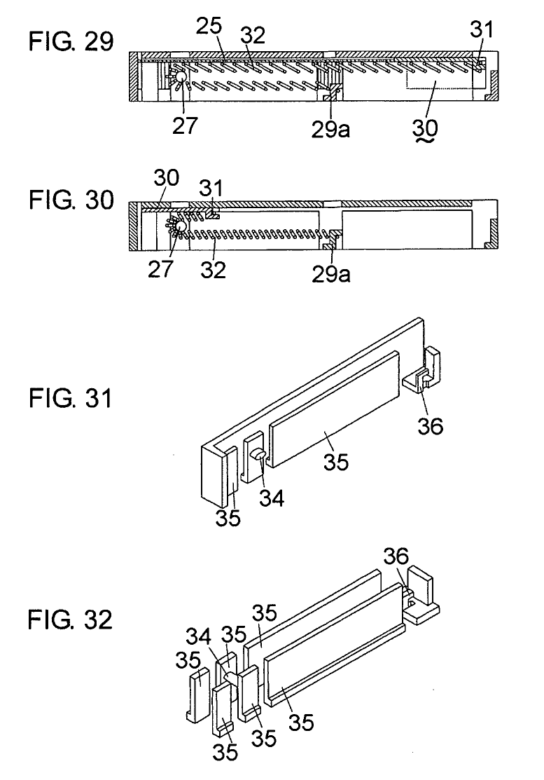

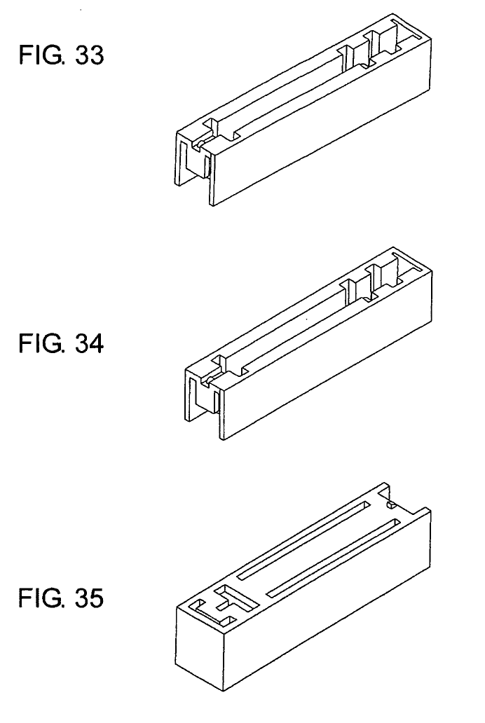

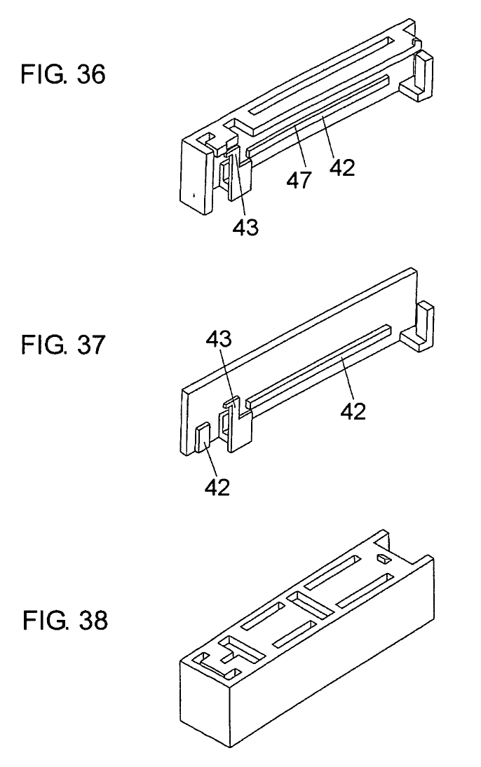

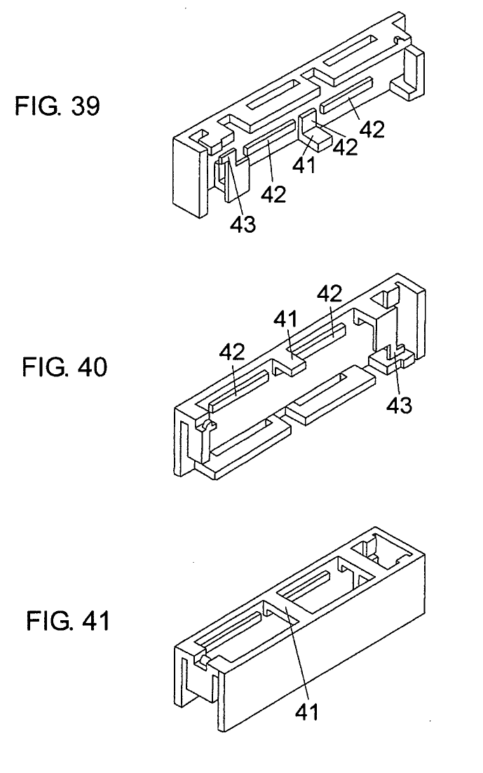

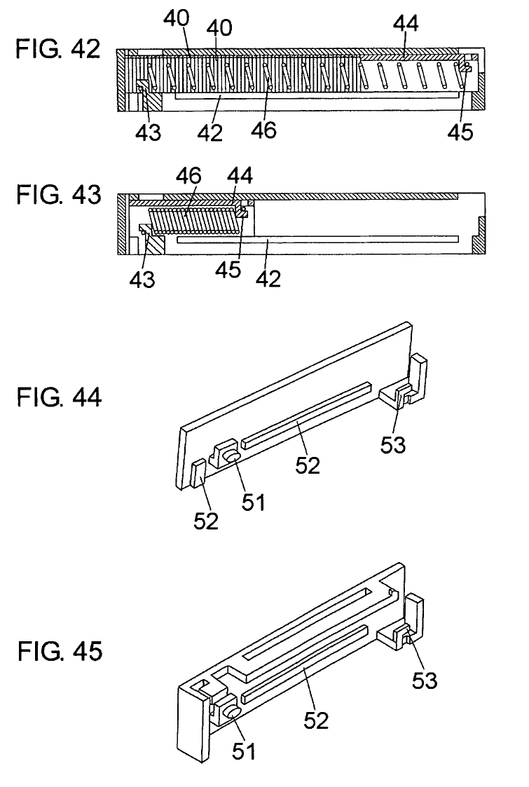

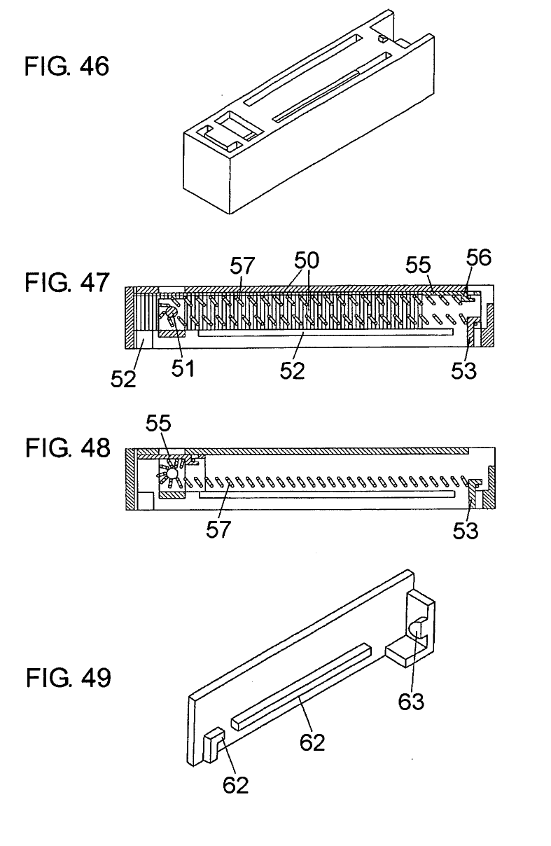

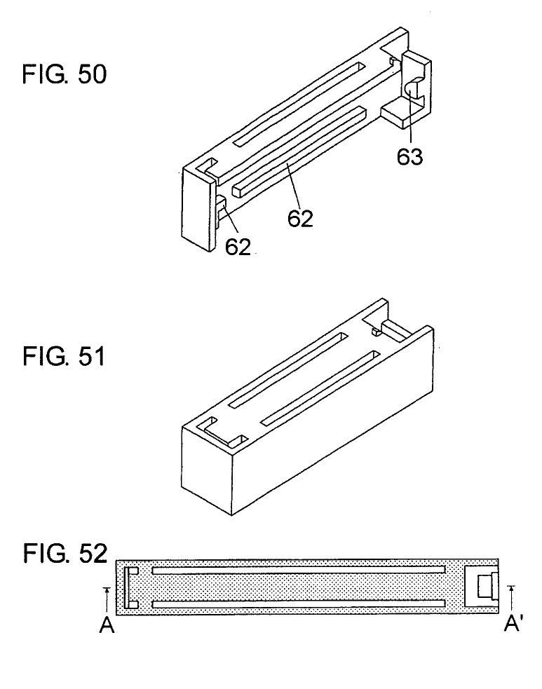

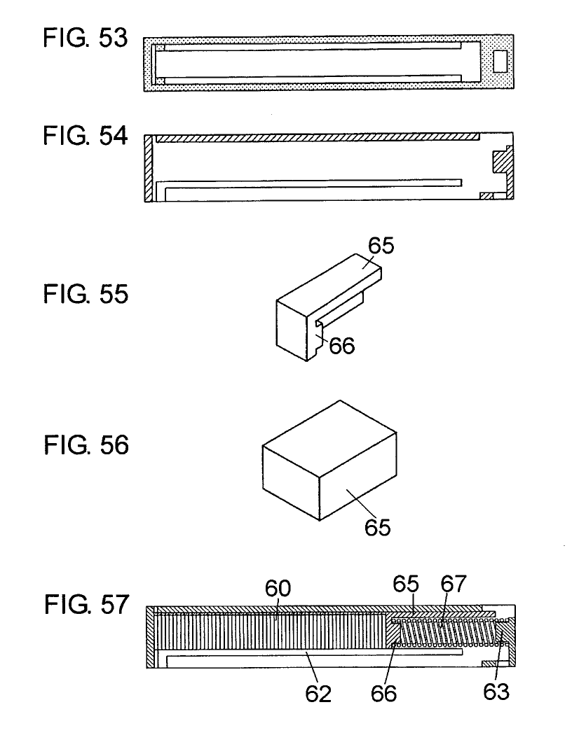

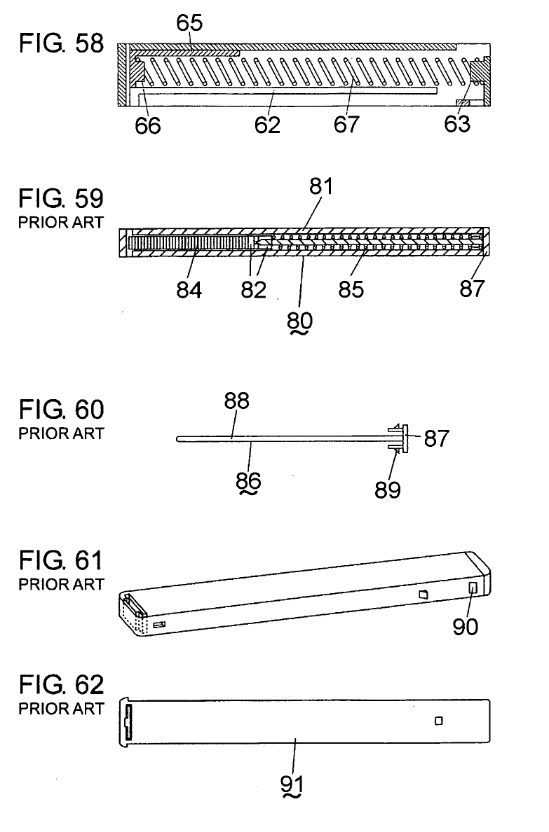

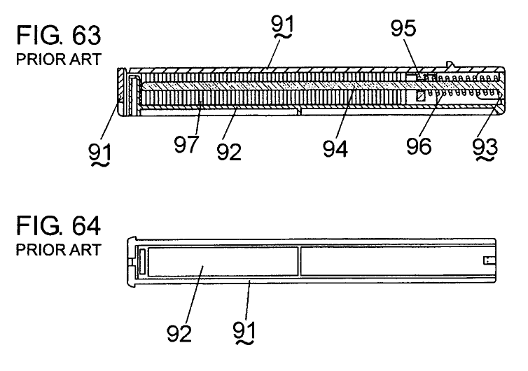

### DESCRIPTION OF REFERENCE NUMERALS AND SIGNS

1 - - - Holder Structure, 2 - - - Holder Front Side, 3 - - - Holder Right Side, 4 - - - Holder Top Side, 5 - - - Holder Left Side, 6 - - - Holder Bottom Side, 7 - - - Holder Back Side, 8 - - - Staple Guide, 9 - - - Spring Engaging Member, 10 - - - Engaging Projection, 11 - - - Feeder Hole, 12 - - - Recess, 13 - - - Recess, 14 - - - Stapler Engaging Projection, 15 - - - Staple, 16 - - - Beam, 17 - - - Recess, 20 - - - Feeder, 21 - - - Feeder Projection, 22 - - - Spring, 25 - - - Staple, 26 - - - Beam, 27 - - - Spring Guide, 28 - - - Staple Guide, 29 - - - Spring Engaging Member, 30 - - - Feeder, 31 - - - Feeder Projection, 32 - - - Spring, 34 - - - Spring Guide, 35 - - - Staple Guide, 36 - - - Spring Engaging Member, 40 - - - Staple, 41 - - - Beam, 42 - - - Side Wall Staple Guide, 43 - - - Spring Engaging Member, 44 - - - Feeder, 45 - - - Feeder Projection, 46 - - - Spring, 50 - - - Staple, 51 - - - Spring Guide, 52 - - - Side Wall Staple Guide, 53 - - - Spring Engaging Member, 54 - - - Small Projection, 55 - - - Feeder, 56 - - - Feeder Projection, 57 - - - Spring, 60 - - - Staple, 62 - - - Side Wall Staple Guide, 63 - - - Spring Engaging Member, 65 - - - Feeder, 66 - - - Feeder Spring Engaging Portion, 80 - - - Cassette, 81 - - - Holder Member, 83 - - - Feeder Device, 84 - - - Staple, 85 - - - Spring, 86 - - - Rod Structure, 87 - - - Cap, 88 - - - Rod, 89 - - - Engaging Projection, 90 - - - Hole, 91 - - - Holder Member Body, 92 - - - Holder Member Bottom Wall, 93 - - - Rod Structure, 94 - - - Rod, 95 - - - Feeder, 96 - - - Spring, and 97 - - - Staple.

1. A holder structure to be used as a cassette of a cassette type stapler, comprising: a holder member including a top side portion, a bottom side portion, a right side portion, a left side portion, a front side portion and a back side portion; and a staple guide member extending in the inside of said holder member in the axial direction of said holder member,
wherein areas of the top side portion define surfaces and areas of the bottom side portion define voids corresponding to said areas of the top side portion defining surfaces, and areas of the top side portion define voids and areas of the bottom side portion define surfaces corresponding to said areas of the top side portion defining voids.

2. A holder structure to be used as a cassette of a cassette type stapler, comprising: a holder member including a top side portion, a bottom side portion, a right side portion, a left side portion, a front side portion and a back side portion; and a holder spring engaging member,
wherein areas of the top side portion define surfaces and areas of the bottom side portion define voids corresponding to said areas of the top side portion defining surfaces, and areas of the top side portion define voids and areas of the bottom side portion define surfaces corresponding to said areas of the top side portion defining voids.

3. A holder structure to be used as a cassette of a cassette type stapler, as set forth in claim 2, further comprising:
a staple guide member extending in the inside of said holder member in the axial direction of said holder member,
the staple guide member being formed as upwardly extending extensions of selected ones of said areas of said bottom side portion defining surfaces corresponding to said areas of the top side portion defining voids, said upwardly extending extensions aligning with selected areas of the top side portion defining voids.

4. A holder structure as set forth in claim 3, characterized by comprising a spring guide inside of said holder structure.

5. A cassette for a cassette type stapler, characterized by comprising:
a holder structure to be used as a cassette of a cassette type stapler including: a holder member having a top side portion, a bottom side portion, a right side portion, a left side portion, a front side portion and a back side portion; a holder spring engaging member; and a staple guide member extending in the inside of said holder member in the axial direction of said holder member, wherein all the members are made integral, and
wherein, areas of the top side portion define surfaces and areas of the bottom side portion define voids corresponding to said areas of the top side portion defining surfaces, and areas of the top side portion define voids and areas of the bottom side portion define surfaces corresponding to said areas of the top side portion defining voids;
a feeder member including a feeder spring engaging member; and
a spring engaging at its one end with said holder spring engaging member and at its other end with said feeder spring engaging member.

6. A cassette as set forth in claim 5, characterized by comprising staples pushed-forward by said feeder member to slide along said staple guide.

7. A cassette as set forth in claim 5, characterized in that the spring is a tension spring.

8. A cassette as set forth in claim 7, characterized in that said holder structure has a spring guide, and in that said spring engages with said spring guide between said one end and said other end to have a U-letter shape.

9. A cassette as set forth in claim 5, characterized in that the spring is a push spring.

10. A cassette as set forth in claim 5, characterized in that said staple guide member supports the top backs of the staples.

11. A cassette as set forth in claim 5, characterized in that said staple guide member supports the leading ends of the legs of the staples.
